(19) United States
(12) Patent Application Publication
(10) Pub. No.: US 2022/0063328 A1
(43) Pub. Date: Mar. 3, 2022

(54) Snap-on automotive wheel cover overlay and method for manufacturing same

(71) Applicant: Naje Fattouche, Bowie, MD (US)

(72) Inventor: Naje Fattouche, Bowie, MD (US)

(73) Assignee: Neo Design, LLC, Bowie, MD (US)

(21) Appl. No.: 16/873,960

(22) Filed: Aug. 28, 2020

(51) Int. Cl. B60B 7/08; B60B 7/06

(52) U.S. Cl. CPC B60B 7/08; B60B 7/061; B60B 2900/572; B29C 45/76; B60B 2360/36; B60B 2310/204; B60B 2310/60; B60B 2360/32

(57) ABSTRACT

An improved snap-on automotive wheel cover overlay and method for manufacturing the same, comprising a rigid polymer hook-shaped member extending from an upper end of a flange, wherein said flange is protruding from the rear inward area side of the wheel cover overlay of the present invention and protruding continuously along a right-rigid polymer longitudinal portion and a rigid-right polymer upper arm edge which form a geometric orientation that permits the flanges of the wheel cover overlay of the present invention when inserted into through holes bearing the corresponding shapes of said flanges to firmly attached to a rear surface area of a manufacturer's or aftermarket's wheel cover when snapped into place; and protruding continuously along a left-rigid polymer longitudinal portion and a left-rigid polymer upper arm edge which form a geometric orientation that permits flanges of the wheel cover overlay of the present invention when inserted into through holes bearing the corresponding shapes of said flanges to firmly attach to the rear surface of a manufacturer's or after market's wheel cover when snapped into place. In addition, a three dimensional (3D) scanned imaging of the individual embodiment component parts is generated, after rigorous testing, and is transferred to an injection molding computer to generate the injection molding designed precisely corresponding to each individual component parts of the present invention.

### TECHNICAL FIELD

The presently disclosed subject matter generally pertains to an improved automotive wheel cover overlay, and more specifically to an automotive wheel cover overlay capable of snapping over an identical, previously installed wheel cover of an automobile. The purpose of the formerly described automobile wheel cover overlay is to cover up the latterly described manufacturer's or aftermarket's automobile wheel cover which was damaged, for example, during an automobile collision, or in the absence of an automobile collision but in the presence of other non-collision damage, to provide a snap-on automobile wheel cover overlay of the present invention with an enhanced cosmetic finish and an attractive appearance.

### BACKGROUND

In general, aftermarket components are used to enhance automobile cosmetic appearances which can be added to an automobile to add decoration and customization to a vehicle beyond what is supplied by the vehicle manufacturer. One component is an automobile wheel cover overlay which fits over the manufacturer's or aftermarket's installed automobile wheel cover and provides a customized look. An aftermarket automobile wheel cover overlay is typically custom manufactured to precisely fit over a specific one or more wheel cover of a specific vehicle or vehicles. Commonly, aftermarket automobile wheel cover overlays are finished in a chrome or black finish, thus providing a new look to the automobile installed thereon.

Aftermarket automobile wheel cover overlays are comprised of different shapes and designs and are used to fit over automobile factory wheel covers when said wheel covers are damaged, for example, in an automobile collision or when said wheel covers demonstrate severe wear and tear and are unattractive due to being exposed to the environmental elements for a significant amount of time. When installed, the wheel cover overlays cover the damaged wheel covers and provide the automobiles with new cosmetic and new decorative finishes which enhance said automobiles' appearances and increase their resale value.

Most automobile wheel covers which are known in the prior art are typically designed to replace a damaged manufacturer's or aftermarket's wheel covers. Replacing a manufacturer's or aftermarket's wheel cover requires expending significant resources on labor needed to first remove a manufacturer's or aftermarket's wheel cover, and second to replace a manufacturer's or aftermarket's wheel cover with the replacement aftermarket wheel cover. Next the replacement wheel cover is painted, which blends the wheel cover with the appearance of the rest of the vehicle.

Prior to this invention, most prior art taught automobile wheel covers were used to outright replace manufacturer's or aftermarket's wheel covers when damaged, for example, during a automobile collision, or when damaged, for example, during long exposure to the environmental elements. In addition, these prior art replacement wheel covers and wheel cover overlays used clips, integral legs, snap tabs, protruding strips and adhesive that failed and that led to the wheel covers and the replacement wheel cover overlays frequently separating from rims of the cars or frequently separating from existing, damaged wheel covers respectively.

First, the prior art Van Houten in U.S. Pat. No. 6,517,168 teaches a wheel cover assembly with pocket inserts fastened to the wheel cover using an integral snap tab arrangement including integral snap tabs that extend in an inboard direction from the inboard surface of the wheel cover and that are disposed around each turbine pocket. Second, the prior art Wang in U.S. Pat. Application No. 2007/0096545 teaches a wheel rim covering structure with costal bodies and engraved holes with shrinking hole edge equipped with a plastic made fastener assembly having a suitable length stem. Third, the prior art Wang in U.S. Pat. No. 7,510,248 teaches a wheel rim cover mounting structure having a plurality of equiangularly spaced through holes, a plurality of protruding flanges perpendicularly protruded from the back side of the cover body around the border of each of the through holes and a plurality of plugholes respectively provided at two sides of each of the protruding flanges, etc. Fourth, the prior art Wang in U.S. Pat. Application 2013/0278043 teaches an automobile wheel rim cover having a plurality of mounting holes, a plurality of through holes cut through opposing front and back walls of a cover body thereof corresponding to the mounting holes of the steel wheel, a plurality of upright flanges protruding from the back wall of the cover body around the through holes, a plurality of beveled retaining devices protruding from an outer wall of each upright flange and insertable with the respective upright flanges through the mounting holes of the steel wheel for hooking on a back wall of the rim of the steel wheel. Fifth, the prior art Hsieh in U.S. Pat. No. 9,227,463 teaches an adjustable wheel cover for aluminum alloy rim wherein a peripheral wall is extended axially from an inner surface of the wheel cover and along a periphery of each through hole with an assembly part disposed with a plurality of adjustment holes radially and a locking block on a spring of the fixing part secured in the adjustment hole correspondingly.

The present invention has a unique geometric shape which differs from clips, integral legs, snap tabs, protruding strips and adhesive and prevents vibration from separating the wheel cover overlay of the present invention from a vehicle's original wheel cover after being snapped on. No prior art wheel cover or wheel cover overlay to date has fastening or retaining devices using the geometric shape and material composition similar or identical to the snap on wheel cover technology employed by the present invention. Thus, that because the fastening or retaining devices mounted on the prior art automotive wheel covers and after market wheel covers overlays do not have the requisite geometric shape and overall strength, they require the application of secondary components for affixing an original manufacturer's or aftermarket's automotive wheel cover (i.e. tape, glue, clips, etc.). This makes installation somewhat tedious, inconvenient, expansive and perhaps even messy. Furthermore, these prior art automotive wheel covers and aftermarket wheel cover overlays are prone to loosen over time with repeated use of the automobile, and requiring numerous, labor intensive and costly repairs over the life span of the automobile.

### GENERAL DESCRIPTION

A primary objective of the present invention is to provide an automotive wheel cover overlay that has the identical configuration of a damaged manufacturer's or aftermarket's automotive wheel cover and capable of being securely snapped on into place over the latter, and providing the appearance of a new or enhance manufacturer's or after market's automotive wheel cover without the need of first removing the damaged automotive wheel cover.

Another objective of the present invention is to provide an automotive wheel cover overlay capable of being snapped onto an existing manufacturer's or aftermarket's automotive wheel cover, without requiring the use of double-sided tape or other bonding materials, or clips, to hold the automotive wheel cover overlay in place.

Another objective of the present invention is to provide an automotive wheel cover overlay constructed of rigid material capable of being flexed and optionally constructed of a single piece of polymer material rather than a hybrid polymer material capable of affixing over an existing manufacturer's or aftermarket's wheel cover without any additional components.

Still another objective of the present invention is to provide an improved automotive wheel cover overlay capable of being snapped over a manufacturer's or aftermarket's wheel cover to cover up damage or wear and tear of the latter without being noticeable to consumers that said improved automotive wheel cover overlay had been installed.

Yet another objective of the present invention is to provide an improved automotive wheel cover overlay capable of being snapped over a manufacturer's or aftermarket's wheel cover to cover up damage or wear and tear of the latter without requiring numerous, labor intensive and costly repairs over the life span of the automobile.

In accordance with certain aspects of the presently disclosed subject matter, there is provided an improved automotive wheel cover overlay capable of being snapped over a manufacturer's existing wheel cover to cover up damage or wear and tear of the latter, said automotive wheel cover overlay of the present invention comprising fastening or retaining devices with a unique geometric shape and unique angles used for snapping over corresponding regions of a manufacturer's or aftermarket's existing wheel cover in need of repair or appearance enhancement.

In accordance with further aspects and, optionally, in combination with other aspects of the presently disclosed subject matter, the fastening or retaining devices of the present invention's automotive wheel cover overlay containing the snap-on technology used for snapping over corresponding regions of a manufacturer's existing wheel cover or an existing aftermarket cover is comprised of a hook-shaped member comprising of rigid polymer extending from an upper end of a flange, wherein said flange is protruding from the rear inward side of the wheel cover overlay of the present invention, and protruding continuously along a right-rigid polymer longitudinal portions and a rigid-right polymer upper arm edge which form a geometric orientation that permits the flanges of the wheel cover overlay of the present invention when inserted into through holes bearing the corresponding shapes of said flanges to firmly attached to the rear surface of the manufacturer's or aftermarket's wheel cover when snapped into place; and protruding continuously along a left-rigid polymer longitudinal portion and a left-rigid polymer upper arm edge which form a geometric orientation that permits flanges of the wheel cover overlay of the present invention when inserted into through holes bearing the corresponding shapes of said flanges to firmly attach to the rear surface of the manufacturer's or aftermarket's wheel cover when snapped into place.

In accordance with further aspects and, optionally, in combination with other aspects of the presently disclose subject matter, the fastening or retaining devices of the present invention's automotive wheel cover overlay containing the snap-on technology used for snapping over corresponding regions of a manufacturer's existing wheel cover or an aftermarket's existing wheel cover is comprised of right-rigid polymer hook-shaped members that protrude from either the flanges or the log nut towers and defines an interior region which grippingly engages right portions behind protruding walls of corresponding mounting slots of an existing manufacturer's or aftermarket's wheel cover, and left-rigid polymer hook-shaped members that protrude from either the flanges or the log nut towers and defines an interior region which grippingly engages a left portions behind protruding walls of corresponding mounting slots of an existing manufacturer's or aftermarket's wheel cover.

Still, in accordance with further aspects and, optionally, in combination with other aspects of the presently disclose subject matter, the fastening or retaining devices of the present invention's automotive wheel cover overlay containing the snap-on technology is used for snapping over corresponding regions of an existing manufacturer's or aftermarket wheel cover, wherein upon engagement of said rigid polymer hook-shaped members that protrude from either the flanges or the log nut towers of the present invention's automotive wheel cover overlay with the corresponding portions of a manufacturer's or aftermarket's wheel cover, the present invention's automotive wheel cover overlay is firmly affixed to said manufacturer's or aftermarket's wheel cover.

Still, in accordance with further aspects and, optionally, in combination with other aspects of the presently disclosed subject matter, an interior surface of said automotive wheel cover overlay's fastening and retaining devices of the present invention is contoured to precisely conform to the rear surface behind the protruding walls of corresponding slots of an existing manufacturer's or aftermarket's wheel cover, such that upon engagement of the rigid polymer hook-shaped members that protrude from either the flanges or the log nut towers with the rear or back side walls of said manufacturer's or aftermarket's automotive wheel cover overlay, said automotive wheel cover overlay of the present invention is intended to be flush against the rear surface of the manufacturer's or the aftermarket wheel cover.

Still, in accordance with further aspects and, optionally, in combination with other aspects of the presently disclosed subject matter, the fastening or retaining devices mounted on the flanges or the log nut towers of the automotive wheel cover overlay of the present invention may be composed of a rigid polymer material that can be temporarily flexed during installation of said automotive wheel cover overlay over an existing manufacturer's or aftermarket wheel cover.

Yet, in accordance with further aspects and, optionally, in combination with other aspects of the presently disclosed subject matter, the fastening or retaining devices mounted on the flanges or the log nut towers of the automotive wheel cover overlay of the present invention are manufactured from a rigid material that allows for manipulation of the fastening or retaining devices during installation over an existing manufacturer's or aftermarket's wheel cover to facilitate engagement of the major and the minor rigid polymer hook-shaped members snap-on technology of the present invention with corresponding rear upper surface portion and rear lower surface portion of the protruding walls of the corresponding mounting slots of the existing manufacturer's or aftermarket's wheel cover respectively.

Yet still, in accordance with further aspects and, optionally, in combination with other aspects of the presently disclosed subject matter, the front surface of the automotive wheel cover overlay of the present invention is finished in a decorative finish.

Among advantages of certain embodiments of the presently disclosed subject matter is that the improved automotive wheel cover overlay of the present invention can be snapped on to an existing manufacturer's or after market's existing wheel cover and held firmly in place by means of hook-shaped members of the fastening or retaining devices of the automotive wheel cover overlay of the present invention without requiring the use of double sided tape or clips to hold the automotive wheel overlay in place.

### BRIEF DESCRIPTION OF THE DRAWINGS

In order to understand the invention and to see how it can be carried out in practice, embodiments will be described, by the way of non-limiting examples, with references to accompanying drawings, in which:

FIG. 1A illustrates a front perspective view of the wheel cover overlay of the present invention prior to snap-on installation over an existing vehicle's wheel cover.

FIG. 1B illustrates a front perspective view of the wheel cover overlay of the present invention after snap-on installation over an existing vehicle's wheel cover.

FIG. 2 illustrates a rear elevated perspective view of an existing vehicle's wheel cover of the prior art.

FIG. 3 illustrates a rear surface elevated perspective view of the wheel cover overlay of the present invention.

FIG. 4A illustrates a rear surface elevated perspective view of the wheel cover overlay of the present invention's preferred embodiment.

FIG. 4B illustrates a section diagram of HU 4A of the wheel cover overlay illustrating the present invention's snap-on technology preferred embodiment after installation over an existing wheel cover.

FIG. 5A illustrates a rear surface elevated perspective view of the wheel cover overlay of the present invention's preferred embodiment.

FIG. 5B illustrates a section diagram of FIG. 5A of the wheel cover overlay of the present invention's snap-on technology preferred embodiment after installation over an existing wheel cover.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, and components have not been described in detail so as not to obscure the presently disclosed subject matter.

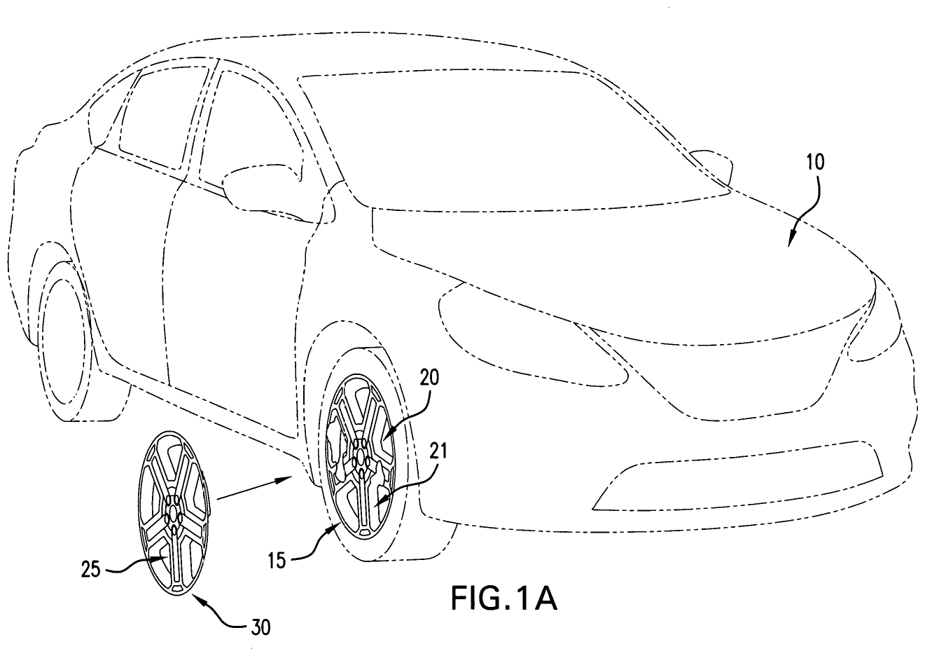

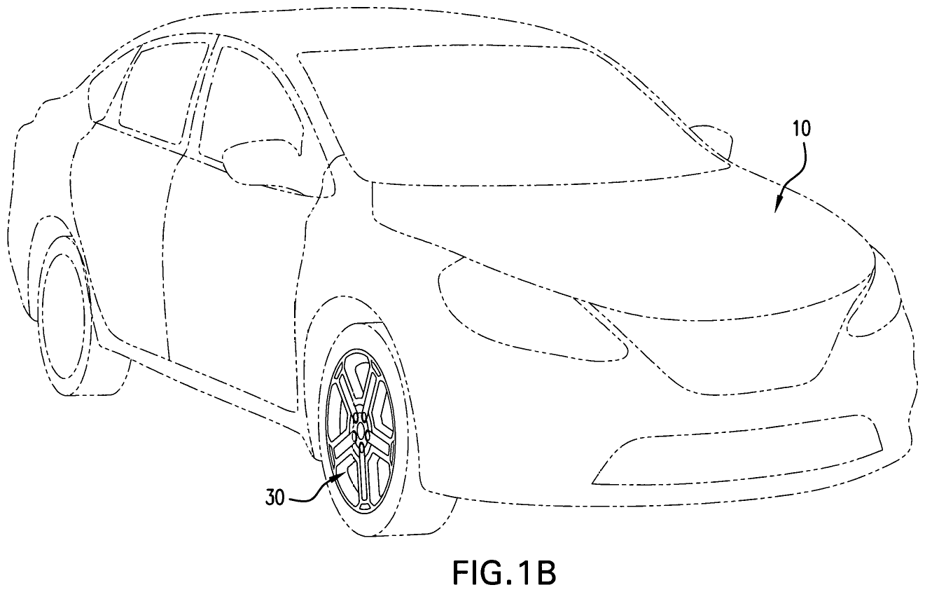

Bearing in mind, attention is drawn to FIGS. 1A and 1B illustrating the wheel cover overlay of the present invention prior to installation and after installation respectively. Said wheel cover overlay is used for covering over a damaged manufacturer's or aftermarket's wheel cover resulting from an automobile accident or resulting from environmental wear and tear and without requiring numerous, labor intensive and costly repairs over the life span of the automobile.

As shown in FIG. 1A, an automobile 10 with a damaged manufacturer's or aftermarket's wheel cover 15 comprises a plurality of mounting slots 20 corresponding to a plurality of through holes 25 of a pre installed wheel cover overlay 30 of the present invention. As shown in FIG. 1B, an automobile 10 with a damaged wheel cover as described in FIG. 1A is fitted with a wheel cover overlay 30 of the present invention. Therefore, as shown in FIG. 1B, a wheel cover overlay 30 of the present invention with identical configuration of a damaged manufacturer's or aftermarket's wheel cover is securely snapped on into place over the former, thereby providing the appearance of a new or enhanced manufacturer's or aftermarket's wheel cover, without the need of removing said damaged manufacturer's or aftermarket's wheel cover 15.

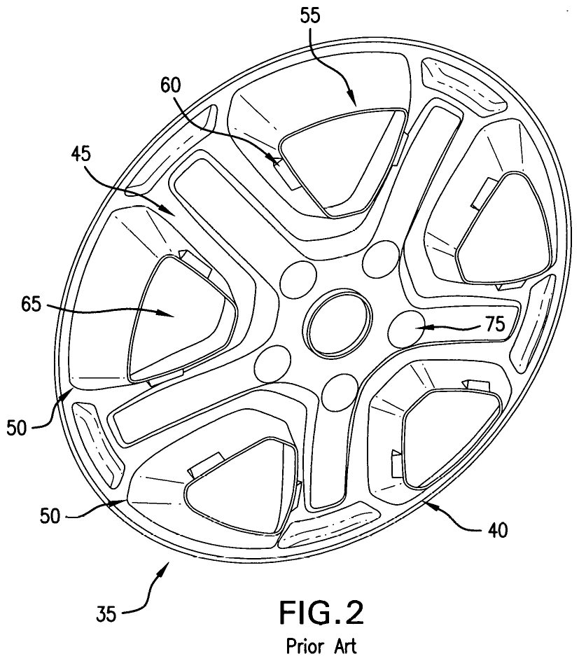

A rear surface of a prior art depicting a wheel cover 35 is illustrated in FIG. 2. Said prior art wheel cover comprises an outer peripheral boundary surface 40, an inward board surface area 45, equally spaced flanges 50 protruding or projecting from the inward board surface area of the rear surface of the wheel cover, and said flanges are formed by lateral walls 55 used for configuring the shapes of said flanges, through holes or cut openings 65 designed to correspond to the mounting slots of a damaged existing wheel cover and snap tabs 60 for snapping the prior art wheel cover onto said damaged existing automotive wheel cover. In addition to snap tabs, the prior art also teaches using clips, and integral legs terminating with a foot, etc. Finally, the prior art of FIG. 2 teaches a plurality of holes 75 carved into the inboard of the rear surface area of the wheel cover corresponding to designs of wheel nuts, which are used for firmly attaching an automobile's rim housing an automobile's tire to an automobile.

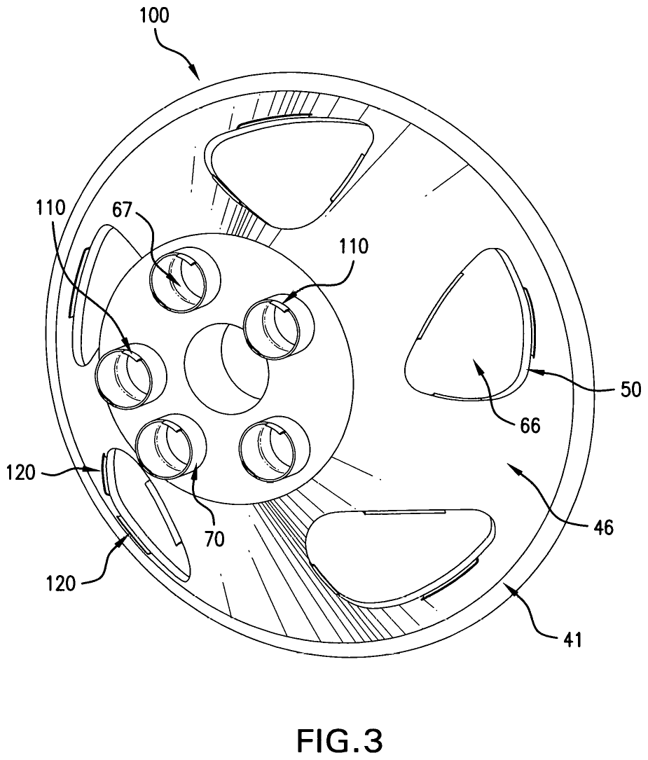

Referring to an embodiment of this present invention, FIG. 3 illustrates a wheel cover overlay 100 comprising an outer peripheral boundary surface 41, a rear inward board surface area 46, a plurality of log nut towers 70, said plurality of log nut towers comprising through holes 67, a plurality of flanges 50, a plurality of through holes 6 and a plurality of minor snap on hook-shaped members 110 protruding from said log nut towers 70.

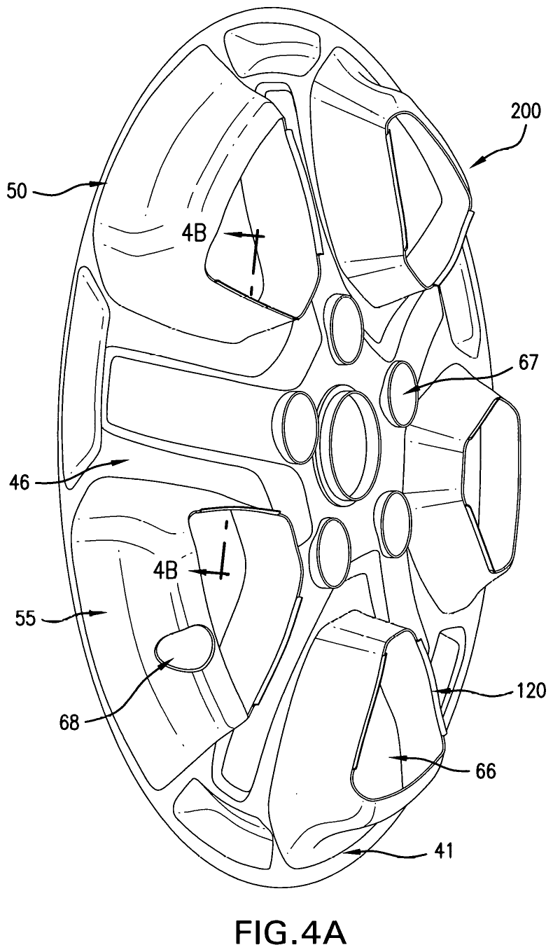

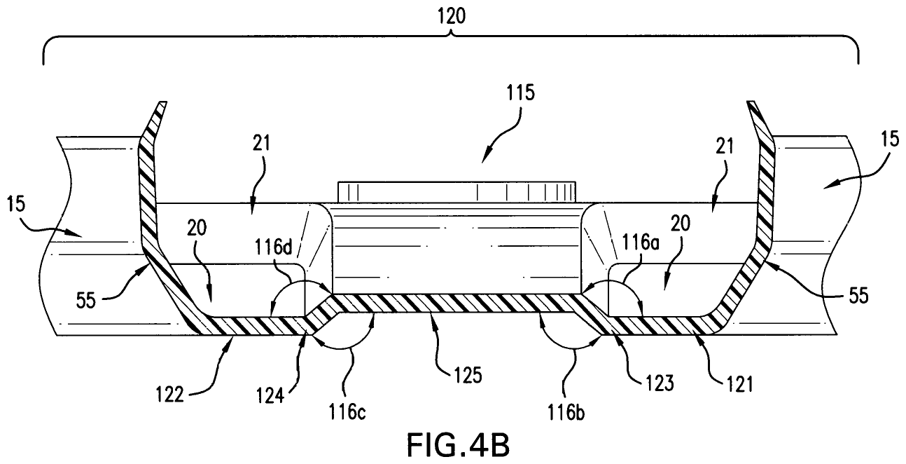

Still referring to a preferred embodiment of the present invention, FIG. 4A illustrates a wheel cover overlay 200 comprising an outer boundary peripheral surface area 41, a rear inward board surface area 46, a plurality of flanges 50 with walls 55 protruding from the rear inward board surface area 46 of the wheel cover overlay and comprising through holes 66, a plurality of major snap on hook-shaped members 120 protruding from said plurality of flanges, and a plurality of through holes 67 directly carved into the surface of the inward board area 46 for receiving wheel nuts without the support log nut towers as compared and illustrated with the embodiment described in FIG. 3. FIG. 4A also has an opening 68 for accommodating an inflation means associated with the tire over which the wheel cover overlay of the present invention is installed.

FIG. 4B illustrates a section diagram of FIG. 4A of the wheel cover overlay of the present invention's snap-on technology preferred embodiment after installation over an existing wheel cover. FIG. 4B illustrates an existing damaged automobile wheel cover 15 having corresponding mounting slots 20 with protruding walls 21 formed on all sides of said mounting slots 20 to give said mounting slots a distinct oval geometric shape, and through which said flanges 50 with protruding walls 55 of the wheel cover overlay of the present invention are inserted through said corresponding mounting slots, and reasonable pressure is applied until the major snap-on technology 120 of the present invention protruding from said flanges 50 are snap-on and latches firmly behind the protruding walls 21 of said corresponding mounting slots 20 of an existing and damaged wheel cover 15.

Still referring to FIG. 4B, the major snap-on hook-shaped member 120 designed on the apex of said corresponding flanges 50 when inserted and firmly snapped on and locked behind the protruding walls 21 of said corresponding mounting slots 20 comprises a right-rigid polymer longitudinal portion 121 which is connected to a right protruding wall 55 of a flange 50, said right and rigid polymer longitudinal portion is connected to a right-rigid polymer arm edge 123, and forming alternate obtuse exterior angles 116a and 116b preferably between 91 degrees 179 degrees, said right-rigid polymer arm edge 123 is connected to a centrally and continuously protruding rigid polymer longitudinal arm 125, which is connected to a left-rigid polymer arm edge 124 forming alternate obtuse exterior angles 116c and 116d with said left-rigid polymer arm edge 124. Still referring to FIG. 4B, said left-rigid polymer arm edge 124 is connected to a left and rigid polymer longitudinal member 122, which in turn is connect to a protruding wall 55 of said flange 50 inserted in said corresponding mounting slot 20 of the damaged existing wheel cover 15.

It should be noted that the entire structure of FIG. 4B and as described in paragraph thirty eight of this application constitutes the snap-on wheel cover overlay assembly 115 of the present invention's major snap-on hook-shaped member 120 preferred embodiment after installation over an existing and damaged wheel cover. It should also be noted that the inventor anticipates right and left rigid polymer arm edges forming right angles (or 90 degrees) and acute angles (or less than 90 degrees) with right and left polymer longitudinal portions respectively, so as to accommodate firmly fitting the snap-on wheel overlay of the present invention over all possible damaged and existing wheel covers needing repairs in the market today. It should further be noted that the minor snap-on hook-shaped member 110 when designed on said log nuts towers will comprise of various forms of rigid polymer arm edges and rigid polymer longitudinal portions, wherein said longitudinal portions and arm edges form preferably obtuse angles when said wheel overlay cover of the present invention is snapped into place to form an installed assembly 115. In addition, the inventor anticipates rigid polymer arm edges forming right angles (or 90 degrees) and acute angles (or less than 90 degrees) with rigid polymer longitudinal portions respectively to accommodate firmly fitting the snap-on wheel overlay of the present invention over all possible damaged and existing wheel covers needing repairs in the market today.

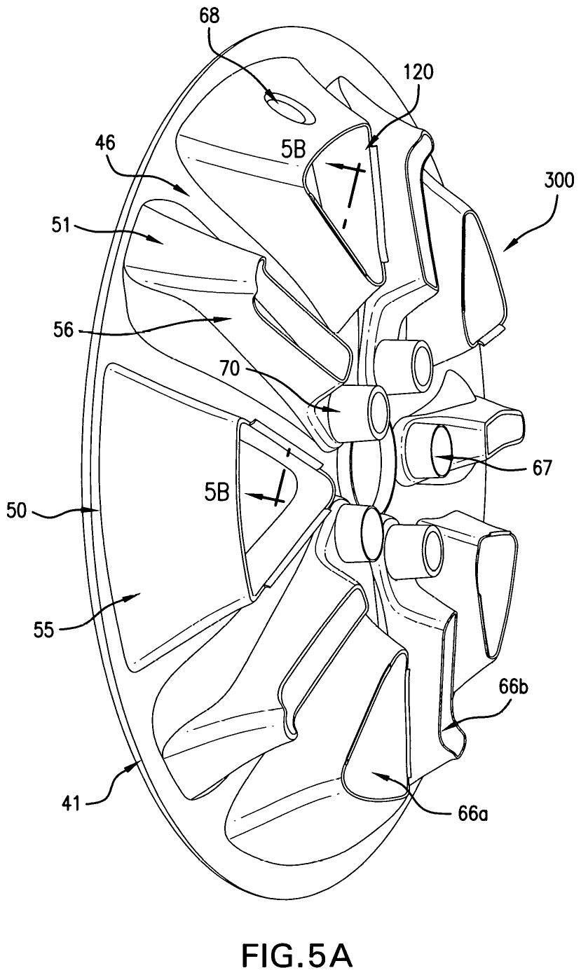

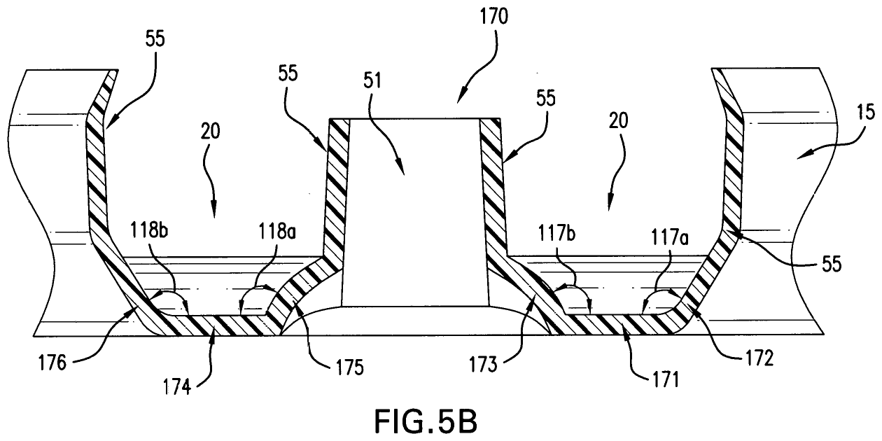

Yet still, referring to a preferred embodiment of the present invention, FIG. 5A illustrates a wheel cover overlay 300 comprising an outer boundary surface 41, a rear inward board surface area 46, a plurality of major flanges 50 with walls 55 protruding from the rear inward board surface area 46 of the wheel cover overlay, a plurality of minor flanges 51 with walls 56 protruding from the rear inward board surface area 46 of the wheel cover overlay, and further comprising major through holes 66a corresponding to the major flanges 50 and minor through holes 66b corresponding to the minor flanges 56, a plurality of major snap on hook-shaped members 120 protruding from said plurality of major flanges, and a plurality of through holes 67 directly carved into the surface area of the inward board 46 for receiving wheel nuts with the support log nut towers 70. FIG. 5A also has an opening 68 for accommodating an inflation means associated with the tire over which the wheel cover overlay of the present invention is installed.

FIG. 5B illustrates a section diagram of FIG. 5A of the wheel cover overlay of the present invention's snap-on technology preferred embodiment after installation over an existing and damaged wheel cover. FIG. 5B illustrates an existing and damaged automobile wheel cover 15 having corresponding mounting slots 20 with protruding walls not illustrated, but formed on all sides of said mounting slots 20 to give said mounting slots a distinct oval geometric shape, and through which said flanges 50 with protruding walls 55 of the wheel cover overlay of the present invention are inserted through said corresponding mounting slots, and reasonable pressure is applied until the major snap-on hook-shaped members 120 of the present invention protruding from said flanges 50 are snapped on and latch firmly behind the protruding walls not illustrated (but similar to the protruding walls in FIG. 4B) of said corresponding mounting slots 20 of an existing and damaged wheel cover 15.

Still referring to FIG. 5A and FIG. 5B, a right-sided major snap-on hook-shaped member 120 designed on the apex of said corresponding major flanges 50 when inserted and firmly snapped on and locked behind the protruding walls not illustrated of said corresponding mounting slots 20 comprises a right-rigid polymer arm edge 171 which is connected to a right protruding wall 55 of a major flange 50, said right-rigid polymer arm edge is connected to a right-central polymer longitudinal portion 173 forming an obtuse angle 117a preferably between 91 degrees 179 degrees, said right-central polymer longitudinal portion 171 is connected to a left-rigid polymer arm edge 173 forming an obtuse angle 117b with said right-central polymer longitudinal portion 171. Still referring to FIG. 5B, said left-rigid polymer arm edge 173 is connected to a left protruding wall 55 of said major flange 50 when inserted in said corresponding mounting slot 20 of a damaged existing manufacturer's or aftermarket's wheel cover 15.

Further, referring to FIG. 5B a left-sided major snap-on hook-shaped member 120 designed on the apex of said corresponding major flanges 50 when inserted and firmly snapped on and locked behind the protruding walls not illustrated (but similar to the protruding walls in FIG. 4B) of said corresponding mounting slots 20 comprises a right-rigid polymer arm edge 175 which is connected to a right protruding wall 55 of a major flange 50, said right-rigid polymer arm edge is connected to a left-central polymer longitudinal portion 174 forming an obtuse angle 118a preferably between 91 degrees 179 degrees, said left-central polymer longitudinal portion 174 is connected to a left-rigid polymer arm edge 176 forming another obtuse angle 118b with said right-central polymer longitudinal portion 174. Still referring to FIG. 5B, said left-rigid polymer arm edge 176 is connected to a left protruding wall 55 of said major flange 50 when inserted in said corresponding mounting slot 20 of a damaged and existing manufacturer's or aftermarket's wheel cover 15.

It should be noted that the entire structure described in paragraph fifty-four constitutes the snap-on wheel cover overlay assembly 170 of the present invention's major snap-on hook-shaped member 120 preferred embodiment after installation over an existing wheel cover. It should also be noted that the inventor anticipates right and left rigid polymer arm edges forming right angles (or 90 degrees) and acute angles (or less than 90 degrees) with right and left polymer longitudinal portions respectively to accommodate firmly fitting the snap-on wheel overlay of the present invention over all possible damaged and existing wheel covers needing repairs in the market today. It should further be noted that the minor snap-on hook-shaped member 110 when designed on said log nuts towers will comprise of various forms of rigid polymer arm edges and rigid polymer longitudinal portions, wherein said longitudinal portions and arm edges form preferably obtuse angles when said wheel overlay cover of the present invention is snapped into place to form an installed assembly 170. In addition, the inventor anticipates rigid polymer arm edges forming right angles (or 90 degrees) and acute angles (or less than 90 degrees) with rigid polymer longitudinal portions respectively, so as to accommodate firmly fitting the snap-on wheel overlay of the present invention over all possible damaged and existing wheel covers needing repairs in the market today. It should be noted that the minor and major hook-shaped members and the left-rigid and right-rigid arm edges, along with all of the longitudinal portions are capable of being designed as both linear and curved versions depending on their applications.

That to produce the finished embodiment described in the specification, suitable polymer materials well known in the art are first selected and tested for strength, durability, malleability and resistance, etc. to meet after-market standards and particularly to meet the rigid original equipment manufacturer (OEM) standards demanded by established automobile manufacturers and distributors. Suitable rigid polymer materials are used straightly and without mixing or proportionally in percentile combination with other polymer materials, including but not limited to, polypropylene, polystyrene, polyethylene, poly vinyl chloride, and acrylonitrile butadiene styrene.

First, these materials (prior to being chrome plated and after being chrome plated) are placed through thermal cycle test(s) and exposed to predetermined temperature to examine for dimensional changes, deformation, clearance gaps, waviness, unevenness, creases, split, crack, breakage, blister, peeling and discoloration, etc. Second, these materials (prior to being chrome plated and after being chrome plated) are placed through chemical resistance test(s) and exposed to predetermined chemical concentrations, such as artificial perspiration, detergent, insect repellent, sun tan oil, sun screening cream and liquid paraffin, etc. to examine for dissolving, cloudiness, stains, discoloration, deformation, uneven surfaces, blooming, sticky surfaces, contamination, glossiness, cracking, breakage, softening, hardening, swelling, thinning and shrinkage, etc. Third, these materials (prior to being chrome plated and after being chrome plated) are placed falling ball impact test(s) by dropping a steel ball from a predetermined height to examine for cracks, breakage, detrimental deformation on the materials visible surface, and for conforming, etc. Fourth, these materials (prior to being chrome plated and after being chrome plated) are placed through pencil scratch test(s) and exposed to predetermined variable models of pencils, so as to examine for surface hardness and scratch resistance, etc. Fifth, these materials (prior to being chrome plated and after being chrome plated) are placed through abrasion resistance test(s) or TABER and exposed to predetermined abrasion wheels, load and rotation speed, etc. so as to examine for glossiness before gloss, after gloss and overall gloss retention. Sixth, these materials (prior to being chrome plated and after being chrome plated) are placed through scratch resistance test(s) and exposed to predetermined load, scratching speed and scratch length using sand paper, glass bead and abrasion tester to examine for based surface exposure, flaw observation rank and the difference between gloss value after test and initial gloss value.

After the suitable materials are selected and tested as describe above, a three dimensional (3D) scanned imaging of the individual embodiment component parts are generated. Next, the three dimensional scanned imaging of said individual embodiment component parts are transferred to an injection molding computer to generate the injection molding designed precisely corresponding to each individual component parts of the three embodiments of the present invention. Next, the desired material (preferably, but not limited to, rigid polymer material) is placed in the injection molding to form the individual component parts. After the individual component parts are formed from the injection molding, a fine tuning/finishing process ensues where the component parts are smoothed to remove all/any sharp and/or rough edges. Finally, the individual component parts of the present invention are chromed to obtain the final product.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter. The snap-on technology of this present invention with variation and unique contours can be used for other car accessories such as wheels, view mirrors, side mirrors, license plate covers, etc. These accessories are capable of being fitted with LEDs as deemed necessary and appropriate and consistent with various regulations.

Those skilled in the art will readily appreciate that various modifications and changes can be applied to the embodiment of the invention as herein before described without departing from its scope, defined in and by the appended claims.

What is claimed is:

1. An improved wheel cover overlay capable of being snapped-on and over an existing manufacturer's or after market's automotive wheel cover and providing the appearance of a new or enhance manufacturer's or after market's automotive wheel cover without the need of first removing said existing automotive wheel cover comprising:
an outer peripheral boundary surface, rear inward board surface area, a plurality of log nut towers wherein said plurality of log nut towers comprising through holes, a plurality of flanges, a plurality of flanges wherein said plurality of flanges comprising through holes and minor snap-on hook-shaped members protruding from said long nut towers.

2. An improved wheel cover overlay as in claim 1, wherein said minor snap-on hook-shaped members are comprise of rigid polymer longitudinal portions and rigid polymer curved arm edges.

3. An improved wheel cover overlay as in claim 2, wherein said minor snap-on hook-shaped members are comprise of obtuse angles.

4. An improved wheel cover overlay as in claim 2, wherein said minor snap-on hook-shaped members are comprise of right angles.

5. An improved wheel cover overlay as in claim 2, wherein said minor snap-on hook-shaped members are comprise of acute angles.

6. An improved wheel cover overlay as in claim 3, wherein said rigid polymer longitudinal portions are comprise of right-rigid polymer longitudinal portions and left-rigid polymer longitudinal portions.

7. An improved wheel cover overlay as in claim 6, wherein said rigid polymer curved arm edges are comprise of right-rigid polymer are edges and left-rigid polymer arm edges.

8. An improved wheel cover overlay capable of being snapped-on and over an existing manufacturer's or aftermarket's automotive wheel cover to cover up damage or wear and tear of the latter without being noticeable to consumers that said improved automotive wheel cover overlay had been installed comprising:
an outer boundary peripheral surface area, a rear inward board surface area, a plurality of flanges with walls protruding from the rear inward board surface area of said wheel cover overlay wherein said flanges comprising a plurality of through holes, a plurality of through holes directly carved into the surface of the inward board area for receiving wheel nuts without the log nut towers, an opening for accommodating inflation means, and a plurality of major snap-on hook-shaped members protruding from said plurality of flanges.

9. An improved wheel cover overlay as in claim 8, wherein said major snap-on hook-shaped members are comprise of rigid polymer longitudinal portions and rigid polymer curved arm edges.

10. An improved wheel cover overlay as in claim 9, wherein said major snap-on hook-shaped members are comprise of obtuse angles.

11. An improved wheel cover overlay as in claim 9, wherein said major snap-on hook-shaped members are comprise of right angles.

12. An improved wheel cover overlay as in claim 9, wherein said major snap-on hook-shaped members are comprise of acute angles.

13. An improved wheel cover overlay as in claim 10, wherein said rigid polymer longitudinal portions are comprise of right-rigid polymer longitudinal portions and left-rigid polymer longitudinal portions.

14. An improved wheel cover overlay as in claim 13, wherein said rigid polymer curved arm edges are comprise of right-rigid polymer are edges and left-rigid polymer arm edges.

15. An improved wheel cover overlay capable of being snapped-on and over an existing manufacturer's or aftermarket's automotive wheel cover constructed of rigid material capable of being flexed and optionally constructed of a single piece of polymer material or a hybrid polymer material capable of affixing over an existing manufacturer's or aftermarket's wheel cover without additional components comprising:
an outer boundary surface, a rear inward board surface area, a plurality of major flanges with walls protruding from the rear inward board surface area of said wheel cover overlay wherein said major flanges comprising major through holes, a plurality of minor flanges with walls protruding from the rear inward board surface area of said wheel cover overlay wherein said minor flanges comprising minor through holes, a plurality of through holes directly carved into the surface area of the inward board for receiving wheel nuts with support log nut towers, an opening for accommodating an inflation means, and a plurality of major snap on hook-shaped members protruding from said plurality of major flanges.

16. An improved wheel cover overlay as in claim 15, wherein said major snap-on hook-shaped members are comprise of rigid polymer longitudinal portions and rigid polymer curved arm edges.

17. An improved wheel cover overlay as in claim 16, wherein said major snap-on hook-shaped members are comprise of obtuse angles.

18. An improved wheel cover overlay as in claim 16, wherein said major snap-on hook-shaped members are comprise of right angles.

19. An improved wheel cover overlay as in claim 16, wherein said major snap-on hook-shaped members are comprise of acute angles.

20. An improved wheel cover overlay as in claim 17, wherein said rigid polymer longitudinal portions are comprise of right-rigid polymer longitudinal portions and left-rigid polymer longitudinal portions.

21. An improved wheel cover overlay as in claim 20, wherein said rigid polymer curved arm edges are comprise of right-rigid polymer are edges and left-rigid polymer arm edges.

22. An improved wheel cover overlay capable of being snapped-on and over an existing manufacturer's or aftermarket's automotive wheel cover comprising:
an outer boundary surface, a rear inward board surface area, a plurality of major flanges with walls protruding from the rear inward board surface area of said wheel cover overlay wherein said major flanges comprising major through holes, a plurality of minor flanges with walls protruding from the rear inward board surface area of said wheel cover overlay wherein said minor flanges comprising minor through holes, a plurality of through holes directly carved into the surface area of the inward board for receiving wheel nuts with support log nut towers, an opening for accommodating an inflation means, a plurality of major snap on hook-shaped members protruding from said plurality of major flanges, and a plurality of minor snap on hook-shaped members protruding from said plurality of minor flanges, and said improved wheel cover is manufactured by process comprising the steps of:
i. selecting suitable polymer materials;
ii. performing thermal cycle testing of said suitable polymer materials;
iii. performing chemical resisting testing of said suitable polymer materials;
iv. performing falling ball impact testing of said suitable polymer materials;
v. performing pencil scratching testing of said suitable polymer materials;
vi. performing abrasion resistance testing of said suitable polymer materials;
vii. performing scratch resistance testing of said suitable polymer materials;
viii. providing a three dimensional scanned imaging of individual component parts;
ix. transferring said three dimensional scanned imaging of said individual component parts to an injection molding computer to generate precise corresponding design of said component parts;
x. placing rigid polymer material in an injection molding to form said individual component parts;
xi. finishing said component parts by smoothing said parts and removing all sharp and rough edges; and
xii. chroming said component parts.

23. An improved wheel cover overlay as in claim 22, wherein said wheel cover is capable of being securely snapped on in place and providing the appearance of a new automotive wheel cover without the need of first removing a damaged automotive wheel cover.

24. An improved wheel cover overlay as in claim 23, wherein said wheel cover is capable of being snapped on without requiring the use of double-sided tape.

25. An improved wheel cover overlay as in claim 24, wherein said wheel cover is capable of being snapped on without requiring integral legs and snap tabs.

26. An improved wheel cover overlay as in claim 25, wherein said wheel cover is capable of being snapped on without requiring adhesive.

27. An improved wheel cover overlay as in claim 26, wherein upon engagement of said minor rigid polymer hook-shaped members and major rigid polymer hook-shaped members said improved wheel cover overlay is firmly affixed to an aftermarket's existing wheel cover.

28. An improved wheel cover overlay as in claim 27, wherein upon engagement of said minor rigid polymer hook-shaped members and major rigid polymer hook-shaped members said improved wheel cover overlay is firmly affixed to a manufacturer's existing wheel cover.

29. An improved wheel cover overlay as in claim 28, wherein said wheel cover is finished in a decorative finish.

30. An improved wheel cover overlay as in claim 29, wherein said wheel cover is composed of a rigid polymer material that temporarily flexed during installation over an existing and damaged wheel cover.
